(19) United States
(12) Patent Application Publication
(10) Pub. No.: US 2006/0179410 A1
(43) Pub. Date: Aug. 10, 2006

(54) Terminal, method, server, and computer program product for switching buddy lists based on user profile

(75) Inventor: Douglas Deeds, Bedford, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/052,406

(22) Filed: Feb. 7, 2005

(51) Int. Cl. G06F 17/00; G06F 15/16; G06F 3/00; G06F 9/00

(52) U.S. Cl. 715/750; 709/206

(57) ABSTRACT

A terminal, method, server, and computer program are capable of executing an instant messaging application. A first user profile and a second user profile are received and stored. A first buddy list associated with the first user profile and a second buddy list associated with the second user profile are also stored. Thereafter, the user profile is switched from the first user profile to the second user profile, such that the first buddy list is deactivated and the second buddy list is activated. The profile switch may be initiated by a user, or may be automatic based on input from a time management application. Additionally, the profile switch may initiate a switch from one instant messaging service to another instant messaging service, or from one username to another username.

### FIELD OF THE INVENTION

The present invention generally relates to instant messaging and, more particularly, relates to a terminal, method, server, and computer program product for sending and receiving instant messages using multiple buddy lists and multiple user profiles.

### BACKGROUND OF THE INVENTION

Sending and receiving short text messages, called instant messaging (IM), is a very popular and productive activity. Instant messaging allows near instantaneous communication among friends, co-workers, and business associates. Friends may use instant messaging to plan social activities or simply to chat, co-workers may use instant messaging to coordinate customer support activities, and business associates may use instant messaging to discuss product specifics or potential orders.

Many different devices may be used for instant messaging, such as mobile telephones, personal computers (PCs), handheld computers, and personal digital assistants (PDAs). These instant messaging devices typically execute an instant messaging application, which communicates over a wired or wireless network to an instant messaging server. The instant messaging server communicates with many other instant messaging devices. Instant messaging services are typically furnished by service providers such as AOL, Yahoo, and MSN. A user who desires to send and receive instant messages establishes an account with one or more of these service providers. Some instant messaging devices, in particular some mobile telephones, may be limited to connecting to only one service provider at a time. Other instant messaging devices may allow simultaneous connections with multiple service providers.

For each account established with an instant messaging service provider, the user selects a unique identifier to be used both to log onto the service and to be identified to other instant messaging users. This unique identifier is alternatively termed a username, a screen name, a nickname, or a handle. A user may have multiple usernames across multiple service providers, or may have multiple usernames on a single service provider. Business users of instant messaging, such as co-workers and business associates, may use a single username to conduct both business and personal communications. For example, an employee of a company may have a username for communicating with customers of the business, and the employee may provide that username to the employee's friends to be able to “chat” with the friends during business hours, as well as during non-business hours. Alternatively, business users of instant messaging may maintain one username for business use and a different username for personal use. Such a business user could be logged onto the two different accounts at the same time (if the instant messaging device allows that) if the user desires to communicate both with business associates and friends, or the user could log onto the business username only during business hours and the personal username only during non-business hours.

In instant messaging applications, a user would typically establish a predefined list of usernames of other users with whom the user wants to make it easier to communicate. Such a predefined list is commonly termed a “buddy list,” and the other users in the predefined list are commonly termed “buddies.” With the buddy list, a user can see which buddies are offline, which buddies are online and available for messaging, which buddies are online but away from their computers (in the case where the instant messaging device is a computer), which buddies have their phones turned off (in the case where the instant messaging device is a mobile phone), which buddies have their phones turned on, or which buddies are currently talking on their phones. These different conditions of availability (online, offline, etc.) are collectively termed presence status. Most of the presence statuses (e.g., online, offline, phone turned off, phone turned on, talking on phone) are determined and displayed automatically by the instant messaging device. However, some presence statuses (e.g., online but away from computer) are selected by the user.

When the user launches the instant messaging application, the application connects to the instant messaging server, logs the user on, and displays the usernames of the user's buddies. The server checks the presence status of the user's buddies and provides a visual indication of each buddy's presence status, typically by changing the typeface of the buddy's displayed username or by displaying a predefined icon adjacent to the buddy's username. Concurrently, the server updates the buddy lists of the user's buddies to indicate that the user is online and available for messaging.

In addition to the presence statuses discussed above, more sophisticated presence status determination and display is possible. For example, presence status has been extended to provide availability status. Availability status information for a user may include whether the user is in a meeting, out of the office, or on vacation, for example. Availability status may be input by the user into the instant messaging device each time the user's availability status changes. Alternatively, the instant messaging application may interface with a calendar or other scheduling application executing on the same device.

A profile is a collection of stored user settings and information. Many types of devices and systems utilize profiles to facilitate quick and easy changing of device settings. Profiles are used in mobile telephones to easily change the audio settings. For example, a user of a mobile telephone may set up three profiles named “outdoor,” “indoor,” and “meeting.” The “outdoor” profile may cause the telephone to audibly ring at the loudest volume when a call is received. The “indoor” profile may cause the telephone to audibly ring at a lower volume when a call is received. The “meeting” profile may cause the telephone to only vibrate when a call is received. Profiles may also control whether particular calls are allowed to ring through. Changing from one profile to another profile is typically accomplished with a small number of keystrokes.

Instant messaging is a useful tool for businesses, especially small businesses. However, many users do not want to mix their business activities with their personal activities, or make themselves available all the time. Having one username and one buddy list that is used for both business and personal communication may make it difficult for a user to separate business activities from personal activities. Such a situation may also significantly reduce the user's efficiency in attending to business activities. It is estimated that a one minute interruption to engage in personal instant messaging results in ten minutes of downtime to return to the prior business activity.

One method of separating business instant messaging from personal instant messaging is to create two separate buddy lists. When the user is engage in business activities, the user would activate the business related buddy list. When the user is engaged in personal activities, the user would activate the personal related buddy list. The user must also set the necessary parameters on the instant messaging device to disallow contact from other users who not in the active buddy list or to prevent the user's visibility from being displayed to other users who are not in the active buddy list. This method of deactivating one buddy list and activating another buddy list may not be desirable for some users, particularly those users with a need to frequently switch between business activities and personal activities, because of the relatively large number of keystrokes required to switch in this manner. Another possible solution is to create two separate usernames, one for business use and one for personal use, with each username having different buddy lists. However, switching between different usernames may require an even larger number of keystrokes and is therefore undesirable.

As such, there is a need for a user of an instant messaging device to be able to separate business communication and personal communication, and to quickly and easily alternate between them.

### BRIEF SUMMARY OF THE INVENTION

A terminal, method, server, and computer program product are therefore provided that allow a user of an instant messaging device to create and store user profiles, with each user profile associated with a different buddy list. The user is able to quickly alternate between user profiles and therefore quickly alternate between buddy lists.

In one embodiment of the invention, a terminal adapted to enable instant messaging by a user comprises a display, a memory, and a processor. The display is capable of visually displaying instant messages. The memory is capable of storing a first and second user profiles that are associated with first and second buddy lists, respectively. The processor is capable of executing an instant messaging application. The processor thereafter is capable of switching from the first user profile to the second user profile such that the first buddy list is deactivated and the second buddy list is activated. By quickly switching from the first user profile to the second user profile, the terminal enables the user, for example, to separate business communication from personal communication in instances in which the buddy list associated with one user profile has business contacts and the buddy list associated with the other user profile has personal contacts.

In one embodiment of the invention, the processor switches from the first user profile to the second user profile in response to a command by the user. In another embodiment of the invention, the processor switches from the first user profile to the second user profile automatically, thereby automatically deactivating the first buddy list and activating the second buddy list. As such, the processor is capable of executing a time management application (e.g., scheduling application or calendar application) and may thereby switch from the first user profile to the second user profile in response to an event in the time management application.

In one embodiment of the invention, the first user profile is associated with a first instant messaging service and the second user profile is associated with a second instant messaging service, such that the processor logs off the first instant messaging service and logs on the second instant messaging service in response to the processor switching from the first user profile to the second user profile.

In one embodiment of the invention, the first user profile is associated with a first username and the second user profile is associated with a second username, such that the processor logs off the first username and logs on the second username in response to the processor switching from the first user profile to the second user profile.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from embodiments of the present invention;

FIG. 2 is a schematic block diagram of an entity capable of operating as a mobile station, server, and/or personal computer (PC) system, in accordance with embodiments of the present invention;

FIG. 3 is a schematic block diagram more particularly illustrating a mobile station in accordance with one embodiment of the present invention; and

FIG. 4 is a flowchart of the operation of switching buddy lists using user profiles, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The terminal, method, server and computer program product of embodiments of the present invention will be primarily described in conjunction with mobile communications applications, and in particular mobile telephones. It should be understood, however, that the terminal, method and computer program product of embodiments of the present invention can be utilized in conjunction with a variety of other applications, both in the mobile communications industries and outside of the mobile communications industries. For example, the terminal, method, server and computer program product of embodiments of the present invention can be utilized in conjunction with wireline and/or wireless network (e.g., Internet) applications. Additionally, the terminal, method, server and computer program product of embodiments of the present invention can be utilized in conjunction with any other devices capable of instant messaging, including but not limited to personal computers, servers, laptop computers, handheld computers, and personal digital assistants.

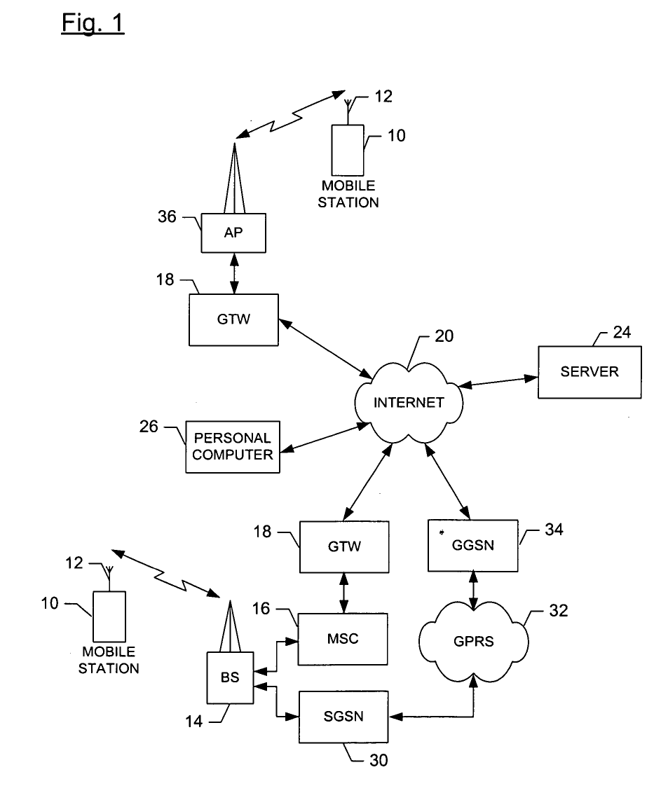

As shown in FIG. 1 by way of example, an illustration of one type of system that would benefit from the present invention is provided. The system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a gateway (GTW) 18, and the GTW is coupled to a WAN, such as the Internet 20. In turn, devices such as processing elements (e.g., personal computers, server computers or the like) can be coupled to the mobile station 10 via the Internet. For example, as explained below, the processing elements can include one or more processing elements associated with one or more servers 24, personal computer (PC) systems 26, or the like, one of each being illustrated in FIG. 1 and described below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 14, the AP's can be directly coupled to the Internet. In one embodiment, however, the APs are indirectly coupled to the Internet via a GTW 18. As will be appreciated, by directly or indirectly connecting the mobile stations and the processing elements (e.g., servers 24, personal computer (PC) systems 26) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to servers 24, personal computer (PC) systems 26 and the like across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques.

As will be appreciated, a number of the entities of the system of FIG. 1 can be configured in any of a number of different architectures to perform any of a number of functions. For example, the entities of the system of FIG. 1 can be configured in a centralized client-server architecture, decentralized architecture and/or proxy architecture. Additionally or alternatively, for example, the entities of the system of FIG. 1 can be configured in an architecture given in the Scalable Network Application Package (SNAP) (formerly Sega Network Application Package) provided by Nokia Corporation for applications such as in the context of gaming.

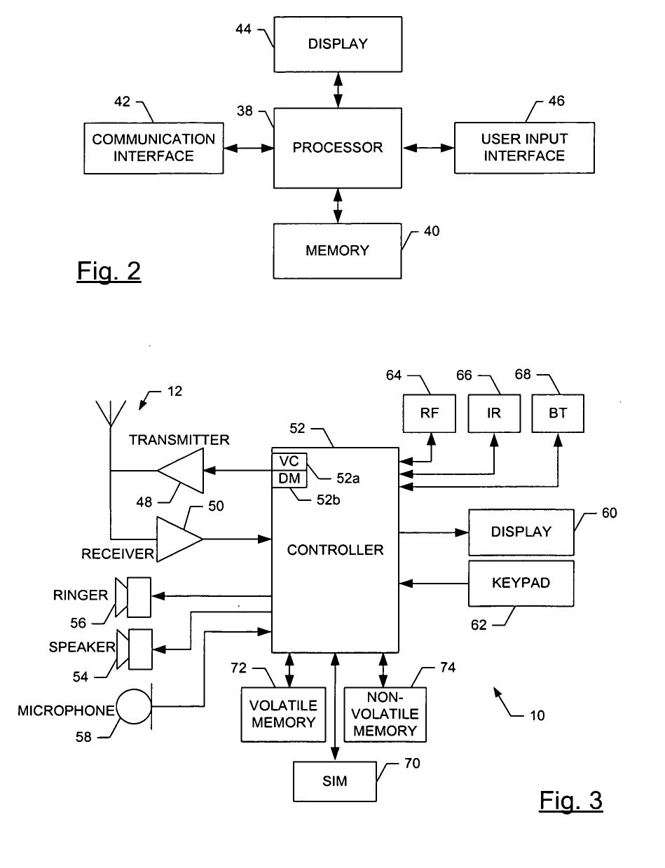

Referring now to FIG. 2, a block diagram of an entity capable of operating as a mobile station 10, server 24, and/or personal computer (PC) system 26, is shown in accordance with one embodiment of the present invention. Although shown as separate entities, in some embodiments, one or more entities may support one or more of a mobile station, server, and/or personal computer (PC) system, logically separated but co-located within the entity(ies). For example, a single entity may support a logically separate, but co-located, game server and routing server. Also, for example, a single entity may support a logically separate, but co-located personal computer and game console.

As shown, the entity capable of operating as a mobile station 10, server 24, and/or personal computer (PC) system 26 generally includes a processor 38 connected to a memory 40. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention. As explained below, for example, the memory can store client application(s) including a configuration utility, content manager and/or display manager. In this regard, when executed, the configuration utility may function to configure a source of content to receive or otherwise provide content. The content manager, when executed, may function to manage the receipt of content from the source, and/or the use of content received from the source. And the display manager may function to manage presentation of content received from the source. As described herein, the client application(s) each comprise software operated by the respective entities. It should be understood, however, that any one or more of the client applications described herein can alternatively comprise firmware or hardware, without departing from the spirit and scope of the present invention.

In addition to the memory 40, the processor 38 can also be connected to at least one interface or other means for displaying, transmitting and/or receiving data, content or the like. In this regard, the interface(s) can include at least one communication interface 42 or other means for transmitting and/or receiving data, content or the like, as well as at least one user interface that can include a display 44 and/or a user input interface 46. The user input interface, in turn, can comprise any of a number of devices allowing the entity to receive data from a user, such as a keypad, a touch display, a joystick or other input device.

Reference is now made to FIG. 3, which illustrates one type of mobile station 10, a mobile telephone, which would benefit from embodiments of the present invention. It should be understood, however, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), two-way pagers, laptop computers, handheld computers, and other types of electronic systems, can readily employ the present invention. Additionally, it should be appreciated that terminals other than mobiles stations, such as personal computers, can readily employ the present invention.

As shown, in addition to an antenna 14, the mobile station 10 can include a transmitter 48, receiver 50, and controller 52 or other processor that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile station may be capable of operating in accordance with 3G wireless communication protocols such as UMTS network employing WCDMA radio access technology. Some NAMPS, as well as TACS, mobile stations may also benefit from the teaching of this invention, as should dual or higher mode phones (e.g., digital/analog or TDMA/CDMA/analog phones).

It is understood that the controller 52 includes the circuitry required for implementing the audio and logic functions of the mobile station 10. For example, the controller may be comprised of a digital signal processor device, a microprocessor device, and various analog-to-digital converters, digital-to-analog converters, and other support circuits. The control and signal processing functions of the mobile station are allocated between these devices according to their respective capabilities. The controller can additionally include an internal voice coder (VC) 52a, and may include an internal data modem (DM) 52b. Further, the controller may include the functionality to operate one or more client software programs such as those indicated above, which may be stored in memory (described below).

The mobile station 10 also comprises a user interface including a conventional earphone or speaker 54, a ringer 56, a microphone 58, a display 60, and a user input interface, all of which are coupled to the controller 52. Although not shown, the mobile station can include a battery for powering the various circuits that are required to operate the mobile station, as well as optionally providing mechanical vibration as a detectable output. The user input interface, which allows the mobile station to receive data, can comprise any of a number of devices allowing the mobile station to receive data, such as a keypad 62, a touch display (not shown), a joystick (not shown) or other input device. In embodiments including a keypad, the keypad includes the conventional numeric (0-9) and related keys (#, *), and other keys used for operating the mobile station. For instant messaging applications, the keypad 62 may include a full QWERTY or other alphanumeric keyboard.

The mobile station 10 can also include one or more means for sharing and/or obtaining data. For example, the mobile station can include a short-range radio frequency (RF) transceiver or interrogator 64 so that data can be shared with and/or obtained from electronic devices in accordance with RF techniques. The mobile station can additionally, or alternatively, include other short-range transceivers, such as, for example an infrared (IR) transceiver 66, and/or a Bluetooth (BT) transceiver 68 operating using Bluetooth brand wireless technology developed by the Bluetooth Special Interest Group. The mobile station can therefore additionally or alternatively be capable of transmitting data to and/or receiving data from electronic devices in accordance with such techniques. Although not shown, the mobile station can additionally or alternatively be capable of transmitting and/or receiving data from electronic devices according to a number of different wireless networking techniques, including WLAN techniques such as IEEE 802.11 techniques or the like.

The mobile station 10 can further include memory, such as a subscriber identity module (SIM) 70, a removable user identity module (R-UIM) or the like, which typically stores information elements related to a mobile subscriber. In addition to the SIM, the mobile station can include other removable and/or fixed memory. In this regard, the mobile station can include volatile memory 72, such as volatile Random Access Memory (RAM) including a cache area for the temporary storage of data. The mobile station can also include other non-volatile memory 74, which can be embedded and/or may be removable. The non-volatile memory can additionally or alternatively comprise an EEPROM, flash memory or the like. The memories can store any of a number of software applications, instructions, pieces of information, and data, used by the mobile station to implement the functions of the mobile station.

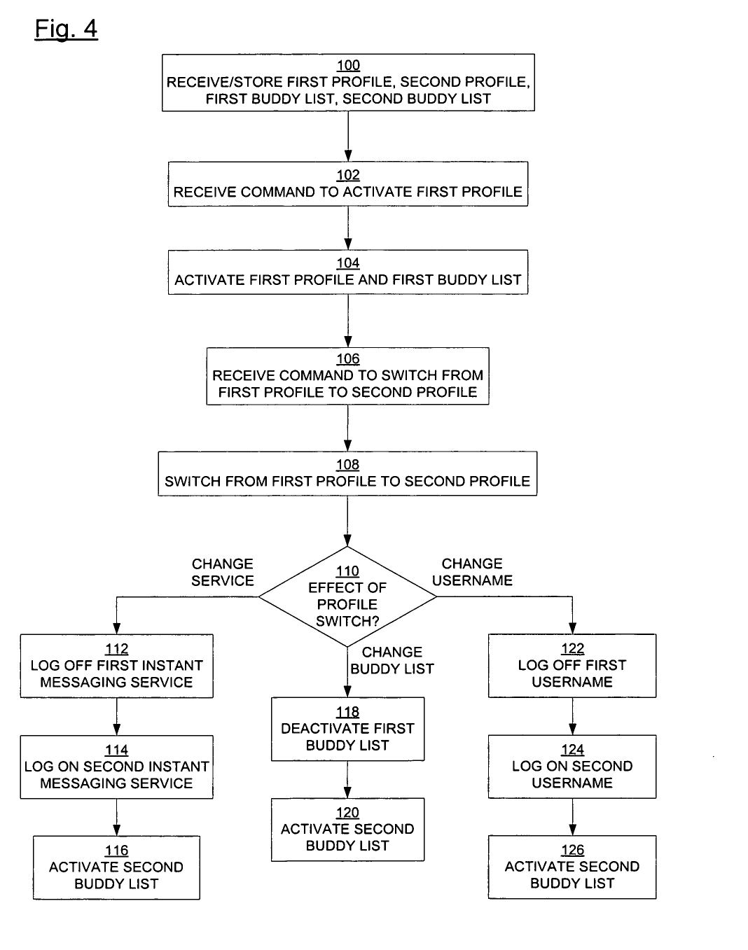

Reference is now made to FIG. 4, which illustrates a flowchart of the operation of switching buddy lists using user profiles, in accordance with one embodiment of the present invention. As shown in block 100, the terminal, method, server, and computer program product of the present invention would typically receive and store a first user profile, a second user profile, a first buddy list associated with the first user profile, and a second buddy list associated with the second user profile. It should be appreciated that, while two user profiles and two buddy lists will be described, the present invention may support a larger number of user profiles and buddy lists.

As discussed above, a profile is a collection of stored user settings and information. For example, profiles are often used in mobile telephones to easily change the audio settings. Mobile telephones typically execute an application that supports establishment of user profiles. Typically, a user would change one or more settings on the user's telephone and then instruct the telephone to store that specific configuration of settings as a profile in the memory of the telephone. The user would typically then be prompted to input a name for the profile, allowing the user to easily distinguish and select that profile at a later time. For example, a user of a mobile telephone may set up two profiles, one named “business” and one named “personal.” It should be appreciated that a typical mobile telephone would support the establishment of a number of profiles well in excess of two, for example as many as twenty-five or fifty profiles depending on the specific telephone.

As discussed above, a buddy list is a list of usernames of other users (i.e., “buddies”) with whom the user wants to communicate using an instant messaging application. A buddy list allows a user can see which of the user's buddies are currently available to communicate and which of the user's buddies are currently unavailable to communicate. Mobile telephones and other terminals typically execute an application that supports establishment of buddy lists. The user typically enters a name for the buddy list that allows the user to easily distinguish and select that buddy list at a later time. The user then typically enters a username into the terminal and specifically into that buddy list, or the user may select an existing username and indicate that the username should be associated with that buddy list. The buddy list would then typically be stored into the memory of the telephone. For example, a user of an instant messaging terminal may set up two buddy lists, one named “co-workers” and one named “friends.” It should be appreciated that a typical terminal would support the establishment of a number of buddy lists well in excess of two, for example as many as twenty-five or fifty buddy lists depending on the specific terminal. When activated, a buddy list provides a visual indication of each buddy's presence status, typically by changing the typeface of the buddy's displayed username or by displaying a predefined icon adjacent to the buddy's username. A user typically communicates with a buddy on the active buddy list by selecting that buddy's username and typing an instant message.

When profiles and buddy lists have been established and stored on a terminal, such as a mobile telephone, the user may associate a specific profile with a specific buddy list. This association may typically be performed as part of the initial set-up of a profile, as part of the initial set-up of a buddy list, or at any time after the initial set-up. The application that supports the establishment of profiles and buddy lists may simply allow this association, or may prompt the user to make this associate during initial set-up.

In an alternative embodiment, the user may establish profiles, buddy lists, and associations between profiles and buddy lists on a separate application executing on a PC, remote server, or other processing device and download the profiles, buddy lists, and associations to the user's mobile telephone or other terminal.

It should be appreciated that the association between profiles and buddy lists does typically not have to be one-to-one. For example, one buddy list may be associated with two different profiles on a user's instant messaging terminal, such that either profile would activate the same buddy list.

It should also be appreciated that user profiles, buddy lists, and associations between profiles and buddy lists can typically be changed or deleted at any time after they have been established.

In addition to associating user profiles with buddy lists, user profiles may be associated with other instant messaging attributes or functions. As discussed above, a user may establish accounts with more than one instant messaging service provider. Additionally, a user may have more than one instant messaging username. Instead of or in addition to switching from one buddy list to another, a user may desire to switch from one service provider to another or from one username to another. In one embodiment of the present invention, a user profile may be associated with a predefined instant messaging service provider, such that switching from a first profile to a second profile causes the processor of the terminal to log off a first service provider and log on a second service provider. In another embodiment of the present invention, a user profile may be associated with a predefined instant messaging username, such that switching from a first profile to a second profile causes the processor of the terminal to log off a first username and log on a second username. Switching profiles in order to switch service providers or usernames may or may not also switch buddy lists. The two different accounts with the two different service providers would typically, although not necessarily, be associated with different buddy lists, and as such switching service providers would typically switch buddy lists. The two different usernames would also typically, although not necessarily, be associated with different buddy lists, and as such switching usernames would typically switch buddy lists.

It should also be appreciated that an instant messaging terminal may support having two or more usernames active (i.e., logged on to) at one time. In such a situation, all active usernames may be associated with the same instant messaging service provider or the active usernames may each be associated with a different instant messaging service provider. As such, two or more usernames may be associated with a user profile, and switching to such a profile would cause the processor of the terminal to log on to the two or more usernames. As each username may be associated with a different buddy list, switching to such a user profile may activate the two or more different buddy lists respectively associated with the two or more different usernames.

Referring again to FIG. 4, the next step generally would be for the processor of the instant messaging terminal to receive a command to activate the first profile, as shown in block 102. The user of the present invention may initiate this command, typically by pressing one or more keys on the instant messaging terminal, or it may be initiated automatically, such as by a time management application executing concurrently with the instant messaging application. The time management application may be, for example, a calendar or scheduling application. For example, when the user is leaving work at the end of the day, the user may manually change the profile from “business” to “personal.” Alternatively, the user's scheduling application may indicate that the user's workday ends at 6:00 PM, and as such the scheduling application would automatically change the profile from “business” to “personal” at 6:00 PM. Thereafter, the first profile is activated which in turn activates the first buddy list associated with the first profile, as shown in block 104. When the first buddy list is activated, the instant messaging terminal communicates with an instant messaging server provided by the instant messaging service provider to determine the presence status of the users on the first buddy list. The first buddy list is then typically displayed on the instant messaging terminal, with visual indications of each buddy's presence status, as discussed above. Similarly, the user's presence status would typically be communicated to those on the user's buddy list. The user of the present invention may then send and receive instant messages from other users on the first buddy list via the system shown in FIG. 1. Sending a message is typically accomplished by the user selecting a username from the user's buddy list and then typing an instant message. Any buddies on the user's active buddy list are able to send messages to the user.

At some point thereafter, the processor of the terminal may receive a command to switch from the first profile to the second profile, as shown in block 106. The user of the present invention may initiate this command, again typically by pressing one or more keys on the instant messaging terminal, or it may be initiated automatically, such as by a calendar or scheduling application executing concurrently with the instant messaging application. The user would typically initiate this command when the user desires to no longer send instant messages to and receive instant messages from other users on the first buddy list, but rather desires to send instant messages to and receive instant messages from other users on the second buddy list. Alternatively, the calendar or scheduling application may initiate this command when a predefined event has occurred or at a predefined time of day. For example, if a user's first buddy list includes business contacts and the second buddy list includes personal contacts, the user may configure the processor of the terminal to switch from the first profile to the second profile at the end of the business day (e.g., at a predefined time such as 6:00 PM on business days), thereby ending and preventing communications with those on the first buddy list, obtaining and displaying the presence status of those on the second buddy list, and permitting communications with those on the second buddy list.

As indicated in block 110, the effect of switching from the first profile to the second profile may depend on the specific embodiment of the present invention. FIG. 4 illustrates the operation of three different embodiments of the invention. These three embodiments are intended for illustration purposes and not intended to limit the scope of the invention. Switching from the first profile to the second profile may deactivate the first buddy list, as shown in block 118, and activate the second buddy list, as shown in block 120. As discussed above, activating the second buddy list causes the list of buddies in the second buddy list to be displayed, along with a visual indication of each buddy's presence status. Alternatively, switching profiles may result in switching from one instant messaging service to another instant messaging service, which also typically results in switching buddy lists. After or concurrent with switching from the first profile to the second profile, the processor of the terminal would typically log off the first instant messaging service, as shown in block 112, and then log on the second instant messaging service, as shown in block 114. This would then typically activate the second buddy list that is recognized by the second messaging service, as shown in block 116. Logging off the first instant messaging service and logging on the second instant messaging service typically involves communication between the terminal and the first and second messaging service providers via the system of FIG. 1. The processor of the terminal would typically transmit a logoff message to the first messaging service provider. The processor of the terminal would then typically transmit a logon request, along with the user's password, to the second messaging service provider. After or concurrent with the terminal receiving a confirmation of a successful logon from the second service provider, the processor of the terminal would activate the second buddy list, communicate with the second instant messaging service provider to determine the presence status of the users on the second buddy list, and display the second buddy list with visual indications of each buddy's presence status. In another alternative embodiment, switching profiles may result in switching from one username to another username, which would again typically result in switching buddy lists. After or concurrent with switching from the first profile to the second profile, the present invention would typically log off the first username, as shown in block 122, and then log on the second username, as shown in block 124. This would then typically activate the second buddy list, as shown in block 126. Logging off the first username and logging on the second username typically involves communication between the terminal and the messaging service provider via the system of FIG. 1. The processor of the terminal would typically transmit a logoff message for the first username to the service provider. The processor of the terminal would then typically transmit a logon request for the second username, along with the user's second username password, to the service provider. After or concurrent with the terminal receiving a confirmation of a successful logon to the second username, the processor of the terminal would activate the second buddy list, communicate with the service provider to determine the presence status of the users on the second buddy list, and display the second buddy list with visual indications of each buddy's presence status.

It should be appreciated that a user profile may not have any buddy list, username, or instant messaging service associated with the user profile. As such, when the processor of the terminal switches from a first profile having an associated buddy list, username, and/or instant messaging service to a second profile not having an associated buddy list, username, and/or instant messaging service, the processor would deactivate the buddy list, username, and/or instant messaging service associated with the first profile but not activate another buddy list, username, and/or instant messaging service. Similarly, when the processor of the terminal switches from a first profile not having an associated buddy list, username, and/or instant messaging service to a second profile having an associated buddy list, username, and/or instant messaging service, the processor would activate the buddy list, username, and/or instant messaging service associated with the second profile without first deactivating another buddy list, username, and/or instant messaging service.

The embodiments described above typically provide for storing the user profiles, buddy lists, and associated information on the instant messaging terminal. It should be appreciated that alternative embodiments of the present invention could provide for storing the user profiles, buddy lists, and associated information at a central location, such as an instant messaging server provided by the service provider. In such an embodiment, a thin application would typically execute on the terminal and would interface with an application executing at the central location. The thin application would typically enable the user to establish user profiles and buddy lists which would then be stored at the central location. The thin application would typically enable the user to request a switch from one user profile to another user profile and communicate this request to the central location. The application executing at the central location would then typically execute the requested profile change, make the corresponding switch from one buddy list to another, and communicate the usernames and presences statuses for the new buddy list to the terminal. The terminal would then typically display this information provided by the central location.

The method of switching buddy lists based on user profile may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIG. 4 is a flowchart of methods and program products according to the invention. It will be understood that each step of the flowchart, and combinations of steps in the flowchart, can be implemented by computer program instructions. These computer program instructions may be loaded onto one or more computers or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

The terminal, method, server, and computer program product of the present invention enable a user to quickly alternate between user profiles and therefore quickly alternate between buddy lists, service providers, and/or usernames, with fewer keystrokes than might otherwise be required to alternate to accomplish such switches. As such, the user is able to quickly and easily choose with whom the user wants to communicate. This allows the user, for example, to separate business communication from personal communication.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A terminal adapted to enable instant messaging by a user, wherein the terminal comprises:
a display capable of visually displaying instant messages;
a memory capable of storing a first user profile and a second user profile, the memory further capable of storing a first buddy list associated with the first user profile and a second buddy list associated with the second user profile; and
a processor capable of executing an instant messaging application, the processor further capable of switching from the first user profile to the second user profile such that the first buddy list is deactivated and the second buddy list is activated as a result of the processor switching from the first user profile to the second user profile.

2. The terminal of claim 1, wherein the processor switches from the first user profile to the second user profile in response to a command by the user.

3. The terminal of claim 1, wherein the processor switches from the first user profile to the second user profile automatically, thereby automatically deactivating the first buddy list and activating the second buddy list.

4. The terminal of claim 3, wherein the processor is further capable of executing a time management application, and wherein the processor switches from the first user profile to the second user profile in response to an event in the time management application.

5. The terminal of claim 1, wherein the first user profile is associated with a first instant messaging service and the second user profile is associated with a second instant messaging service, and wherein the processor is further capable of logging off the first instant messaging service and logging on the second instant messaging service in response to the processor switching from the first user profile to the second user profile.

6. The terminal of claim 1, wherein the first user profile is associated with a first username and the second user profile is associated with a second username, and wherein the processor is further capable of logging off the first username and logging on the second username in response to the processor switching from the first user profile to the second user profile.

7. A method for switching buddy lists on a terminal adapted to enable instant messaging by a user, the method comprising:
operating an instant messaging application in conjunction with a first user profile that is associated with a first buddy list; and
switching from the first user profile to a second user profile such that the first buddy list is deactivated and a second buddy list associated with the second profile is activated as a result of switching from the first user profile to the second user profile.

8. The method of claim 7, further comprising:
storing the first user profile and the second user profile; and
storing the first buddy list associated with the first user profile and the second buddy list associated with the second user profile.

9. The method of claim 7, wherein switching from the first user profile to the second user profile occurs in response to a command by the user.

10. The method of claim 7, wherein switching from the first user profile to the second user profile occurs automatically, thereby automatically deactivating the first buddy list and activating the second buddy list.

11. A computer program product for switching buddy lists on a terminal adapted to enable instant messaging by a user, the computer program product comprising at least one computer-readable storage medium having computer-readable program code portions stored therein, the computer-readable program code portions comprising:
a first executable portion capable of operating an instant messaging application in conjunction with a first user profile that is associated with a first buddy list; and
a second executable portion capable of switching from the first user profile to a second user profile such that the first buddy list is deactivated and a second buddy list associated with the second profile is activated as a result of switching from the first user profile to the second user profile.

12. The computer program product of claim 11, further comprising:
a third executable portion capable of storing the first user profile and the second user profile; and
a fourth executable portion capable of storing the first buddy list associated with the first user profile and the second buddy list associated with the second user profile.

13. The computer program product of claim 11, wherein the second executable portion switches from the first user profile to the second user profile in response to a command by the user.

14. The computer program product of claim 11, wherein the second executable portion switches from the first user profile to the second user profile automatically, thereby automatically deactivating the first buddy list and activating the second buddy list.

15. The computer program product of claim 14, further comprising a third executable portion capable of executing a time management application, the time management application capable of storing a plurality of events, wherein the second executable portion switches from the first user profile to the second user profile in response to one of the plurality of events in the time management application.

16. The computer program product of claim 11, wherein the first user profile is associated with a first instant messaging service and the second user profile is associated with a second instant messaging service, and wherein the computer program product further comprises a third executable portion capable of logging off the first instant messaging service and logging on the second instant messaging service in response to the second executable portion switching from the first user profile to the second user profile.

17. The computer program product of claim 11, wherein the first user profile is associated with a first username and the second user profile is associated with a second username, and wherein the computer program product further comprises a third executable portion capable of logging off the first username and logging on the second username in response to the second executable portion switching from the first user profile to the second user profile.

18. A server adapted to enable instant messaging by a user, wherein the server comprises:
a memory capable of storing a first user profile and a second user profile, the memory further capable of storing a first buddy list associated with the first user profile and a second buddy list associated with the second user profile; and
a processor capable of executing an instant messaging application, the processor further capable of switching from the first user profile to the second user profile such that the first buddy list is deactivated and the second buddy list is activated as a result of the processor switching from the first user profile to the second user profile.

19. The server of claim 18, wherein the processor switches from the first user profile to the second user profile in response to a command by the user.

20. The server of claim 18, wherein the processor switches from the first user profile to the second user profile automatically, thereby automatically deactivating the first buddy list and activating the second buddy list.
